(19) United States
(12) Patent Application Publication
(10) Pub. No.: US 2013/0304427 A1
(43) Pub. Date: Nov. 14, 2013

(54) Unitized Cladding System, Method, and Software Program

(71) Applicants: Vince Pan, Cambridge, MA (US); Kristian Bodek, Cambridge, MA (US)

(72) Inventors: Vince Pan, Cambridge, MA (US); Kristian Bodek, Cambridge, MA (US)

(73) Assignee: ANALOGUE STUDIO, LLC, Boston, MA (US)

(21) Appl. No.: 13/470,350

(22) Filed: May 13, 2012

(51) Int. Cl. G06F 17/50; G06Q 30/00; F24J 2/52; E04B 1/00; E04B 2/88; E04C 2/52

(52) U.S. Cl. 703/1; 52/235; 52/220.1; 52/173.3; 52/741.1; 705/500

(57) ABSTRACT

A unitized cladding system that incorporates energy reducing and harvesting technologies may be installed on a building's exterior wall to reduce the building's net energy consumption and costs. A method for configuring a unitized cladding system to optimize a building's energy savings involves measuring the building's current energy consumption based on information relating to the building's site and composition, designing and assembling cladding units that incorporate suitable energy saving and harvesting modules, and measuring the effects of the cladding system on the building's net energy consumption. This method may be enabled by a software program product.

### CROSS-REFERENCE TO RELATED APPLICATIONS

This application claims the benefit of U.S. Provisional patent application filed by Vince Pan, Analogue Studio, on May 13, 2011, and titled Unitized Cladding System to Reduce Energy Consumption of Existing Buildings, which is incorporated herein by reference for all purposes.

### STATEMENT REGARDING FEDERALLY SPONSORED RESEARCH OR DEVELOPMENT

Not applicable.

### REFERENCE TO SEQUENCE LISTING, A TABLE, OR A SOFTWARE PROGRAM LISTING COMPACT DISC APPENDIX

Not applicable.

### BACKGROUND OF THE INVENTION

The present invention relates to a unitized cladding system, method, and software program to reduce energy consumption of buildings with integrated energy reducing and harvesting technologies.

Supplementing the envelopes of existing buildings is important to reducing energy consumption and its associated costs. Much of the energy consumed by commercial buildings is spent compensating for poor insulation and an inability to harvest the abundance of free and reliable solar energy. In addition to environmental costs, there are significant economic costs to this excess consumption and significant benefits to its reduction.

Wall cladding units for aesthetic and functional purposes are known in the art, for example U.S. Pat. Nos. 7,866,107 and 5,398,473. Incorporating elements such as solar generators into cladding units for the purpose of energy management is also known, for example U.S. Pat. Nos. 4,228,787 and 7,665,254. Known cladding units and methods involve either replacing the entire envelope of an existing building or applying minimally insulating or energy-generating cladding units on top of an existing building envelope. Replacing the entire envelope is costly, disruptive, and time consuming. Applying individual units of cladding to an existing envelope is also time consuming and results in only minimal energy savings. Known cladding products and methods do not integrate multiple energy production, energy conservation, and increased insulation technologies into their designs. Nor do they support customization of the cladding panels based on site- and project-specific conditions.

The present invention improves on the prior art by providing a product, method, and program that integrates energy production and conservation technologies in pre-fabricated cladding units adapted to site- and project-specific conditions for installation as a lightweight secondary envelope on existing buildings.

### BRIEF SUMMARY OF THE INVENTION

The present invention provides a lightweight unitized cladding system for installation as a supplementary envelope for existing buildings and a method and a software program for customizing the unitized cladding system to site- and project-specific conditions for optimal energy conservation and production.

In one aspect, the present invention comprises a unitized cladding system, and a method of its assembly, comprised of unit frames that can incorporate insulation, cladding, glazing, daylight management, energy production, and air-cleansing modules.

In another aspect, the present invention comprises a method of modeling and estimating energy consumption of an existing building based on data concerning the building's location, dimensions, composition and other factors; customizing and configuring a unitized cladding system for installation on an existing building's exterior to reduce the building's net energy consumption based on site- and project-specific conditions; and modeling and estimating the net reduction in an existing building's energy consumption and energy costs resulting from installation of a customized cladding system on the building exterior, as well as the time period after which the savings in energy costs will have paid for the cost of installing the cladding system (“payback period”).

In another aspect, the present invention comprises a software program for modeling and estimating energy consumption of an existing building based on data concerning the building's location, dimensions, composition and other factors; customizing and configuring a unitized cladding system for installation on an existing building's exterior to reduce the building's net energy consumption based on site- and project-specific conditions; and modeling and estimating the net reduction in an existing building's energy consumption and energy costs resulting from installation of a customized cladding system on the building exterior, as well as the number of years after which the savings in energy consumption will pay for the cost of the unitized cladding system (“payback period”).

The present invention offers advantages not previously known in the art. For example, the present invention integrates multiple pre-fabricated units into a lightweight secondary envelope, combining their impact for maximum energy savings. The components of the secondary envelope are customized according to an existing building's construction and composition, its surrounding environment and location, and its energy needs. Other advantages and novel features of the present invention will become apparent from the following detailed description of various non-limiting embodiments of the invention when considered in conjunction with the accompanying figures.

### BRIEF DESCRIPTION OF THE DRAWINGS

Non-limiting embodiments of the present invention will be described by way of example with reference to the accompanying figures, which are schematic and are not intended to be drawn to scale.

FIG. 1 illustrates an example of a single cladding unit of the present invention, which may be comprised of insulation, cladding, glazing, daylight management, energy production, and air-cleansing modules.

FIG. 2 illustrates example modules that may be integrated into the cladding units of the present invention.

FIG. 3 illustrates an example of the method of customizing the cladding system of the present invention for each façade of an existing building based on solar, wind, shading, and site analysis.

FIG. 4 illustrates an example of the preferred embodiment of the present invention as a secondary envelope surrounding an existing building.

FIG. 5 illustrates example designs that can be achieved by implementing the present invention.

FIG. 6 illustrates an exemplary embodiment of a software program receiving data on a building's location to model and measure the building's current energy costs and potential energy reduction and savings.

FIG. 7 illustrates an exemplary embodiment of a software program receiving data on a building's dimensions to model and measure the building's current energy costs and potential energy reduction and savings.

FIG. 8 illustrates an exemplary embodiment of a software program receiving data on a building's occupancy, construction type, mechanical system, perimeter structural capacity, exterior walls, exterior windows, and flooring to model and measure the building's current energy costs and potential energy reduction and savings.

FIG. 9 illustrates an example of a software program modeling and estimating a building's current energy consumption and potential energy reduction and savings, based on data regarding the building's location, dimensions, occupancy, construction type, mechanical system, perimeter structural capacity, exterior walls, exterior windows, and flooring.

FIG. 10 illustrates an exemplary embodiment of a software program allowing user selection of the desired number of vertical and horizontal units on each building façade to determine the standard unit frame size for that façade.

FIG. 11 illustrates an exemplary embodiment of a software program allowing user selection of desired window head height and sill height, unit attachment method, insulation type, cladding type, glazing type, daylight management features, accessories, and/or roof systems for each façade of the building.

FIG. 12 illustrates an exemplary embodiment of a software program modeling and estimating the total cost of installing the unitized cladding system as a secondary building envelope, the reduction in energy consumption, and the payback period, while allowing user modification of the system design to achieve the desired values for these parameters.

FIG. 13 illustrates another exemplary embodiment of a software program modeling and estimating the total cost of installing the unitized cladding system as a secondary building envelope, the reduction in energy consumption, and the payback period.

### DETAILED DESCRIPTION OF THE INVENTION

The present invention relates to unitized cladding system for installation as a supplementary envelope for existing buildings to reduce energy consumption and increase energy production and to a method and a software program for customizing the unitized cladding system to site- and project-specific conditions and modeling and measuring net reduction in energy consumption and costs.

It is already known in the art to install cladding systems on top of existing façades. The known cladding systems, however, have significant drawbacks. Many of them are intended to provide aesthetic upgrades with minimal performance gains, incorporate few if any technologies for energy management, require extensive assembly in the field, are not designed to perform as a continuous envelope, and do not incorporate a method for adaptation to site- and project-specific conditions.

Unitized curtainwall systems are also known in the art, but they are designed only for construction of new building façades or complete replacement of existing façades.

The present invention adapts principles of unitized curtainwall construction to create a new method and product of unitized cladding for installation on top of existing building façades and a software program for modeling and estimating associated energy and cost savings.

The present invention is an improvement on the prior art in that it provides a cladding system to supplement an existing building envelope's insulating properties with insulating properties of the cladding system and an airspace between the two systems. The additional insulation provided by the airspace and secondary layer reduces energy loss.

The preferred embodiment of the present invention is as a complete secondary envelope that surrounds all faces of the existing building.

The present invention is a further improvement on the prior art in that it integrates various energy producing, air cleansing, insulation, glazing, daylight management, or decorative modules within each cladding unit frame to maximize energy savings and improve air quality, while providing a variety of aesthetic options.

By unitizing the cladding system, the present invention improves on the prior art by allowing for the renovation of multiple buildings with diverse climates, conditions, and designs using a single standardized system. It also facilitates upgrades to the system as new technologies become available.

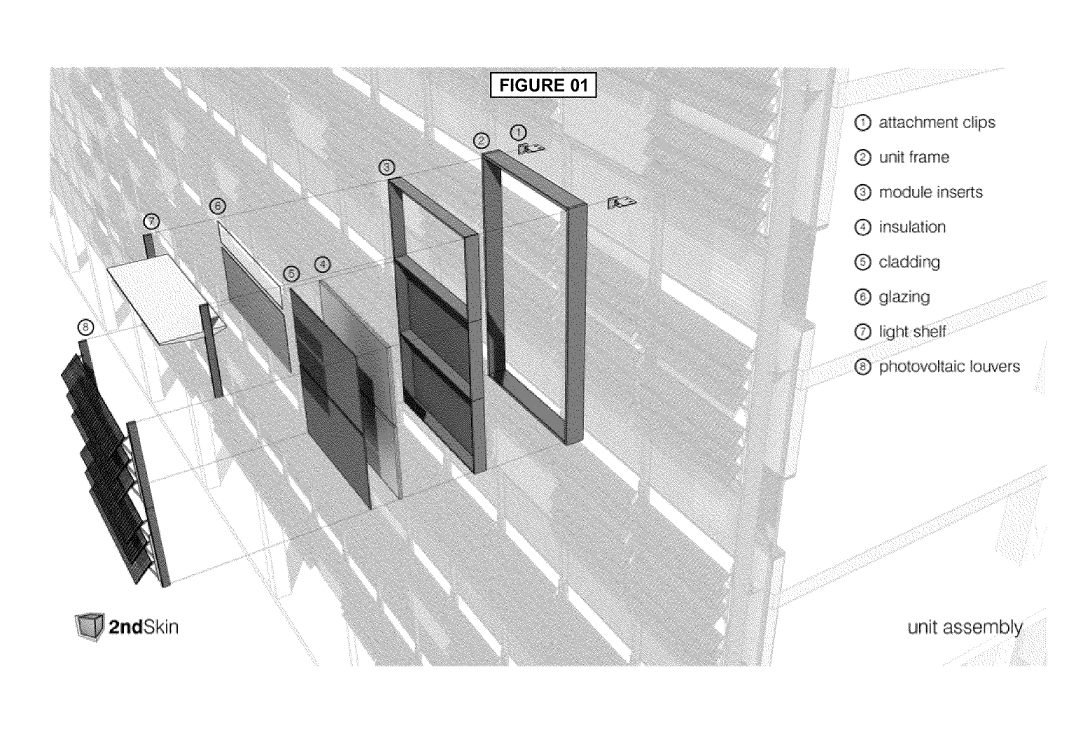

The present invention is a further improvement on the prior art in that the installation method reduces the time and disruption required for installation. The cladding units, an example of which is shown in FIG. 1, are assembled off-site, while the attachment clips are installed on the building façade prior to the on-site arrival of the units from the factory. Once the units have arrived on site, installation involves lifting the cladding panels into place and attaching them to the clips and to one another. Installation time is reduced by minimizing assembly in the field. This process also allows the existing building to remain occupied during the renovation.

The present invention is a further improvement on the prior art in that it is optimized to save weight by using the existing structure for support and lightweight module inserts.

The unitized cladding system of the present invention is comprised of unit frames that are capable of incorporating insulation, cladding, glazing, daylight management, energy production, and air-cleansing modules. An example of a unit frame of the present invention is shown in FIG. 1.

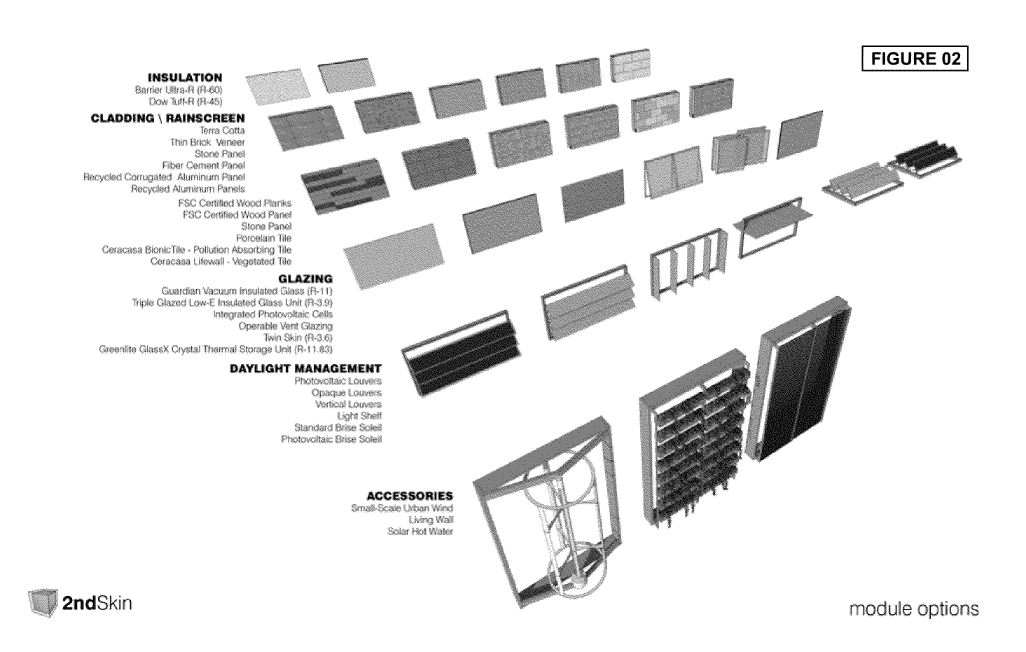

A variety of modules are available to be incorporated into each unit frame, including thin and high R-value lightweight insulation; decorative terra cotta, brick veneer, stone, fiber cement, aluminum, corrugated aluminum, wood plank, engineered wood, and ceramic tile finishes; high R-value glazing, photovoltaic integrated glazing, thermal storage glazing, operable windows, operable photovoltaic louvers, opaque and translucent louvers, vertical shading louvers, light shelves, brise soleil, and photovoltaic brise soleil, small scale wind, vegetated walls, and solar hot water units. Several examples of such modules are shown in FIG. 2.

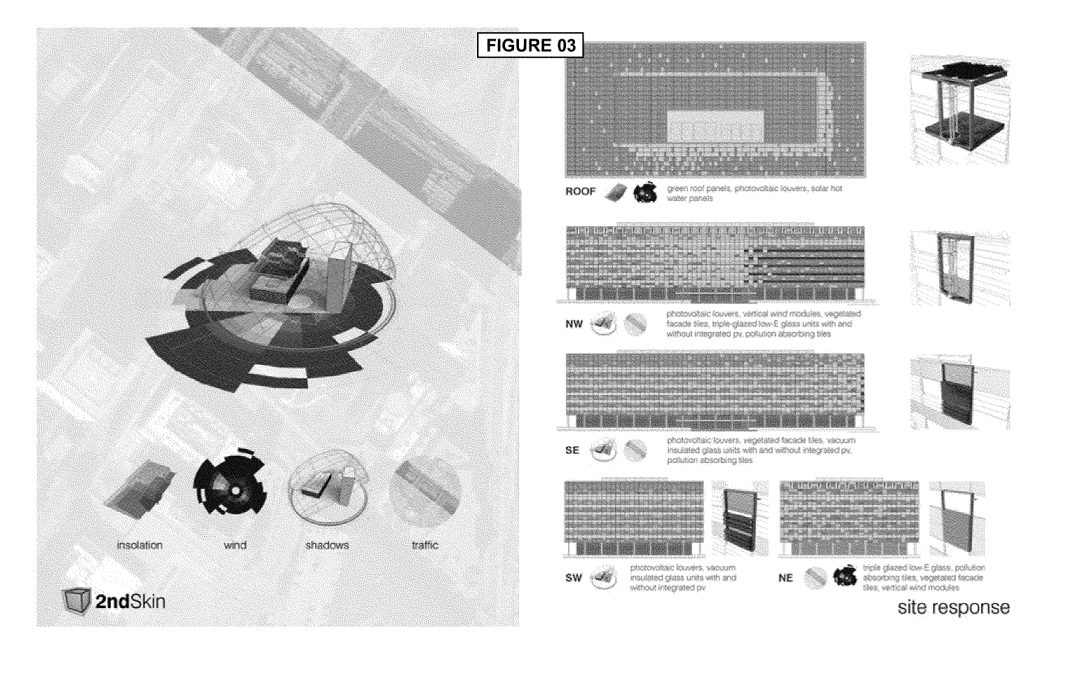

According to the method taught by the present invention, the modules are selected based on several factors relating to the building's site and composition, including geographic location, orientation, dimensions, occupancy, construction type, mechanical system type, perimeter structural capacity, exterior wall construction, exterior window type, floor construction type, roof construction type, and project budget, among other variables. FIG. 3 illustrates an exemplary embodiment of the method of selecting modules to customized the cladding units for each façade of the existing building based on solar, wind, shading, and site analysis.

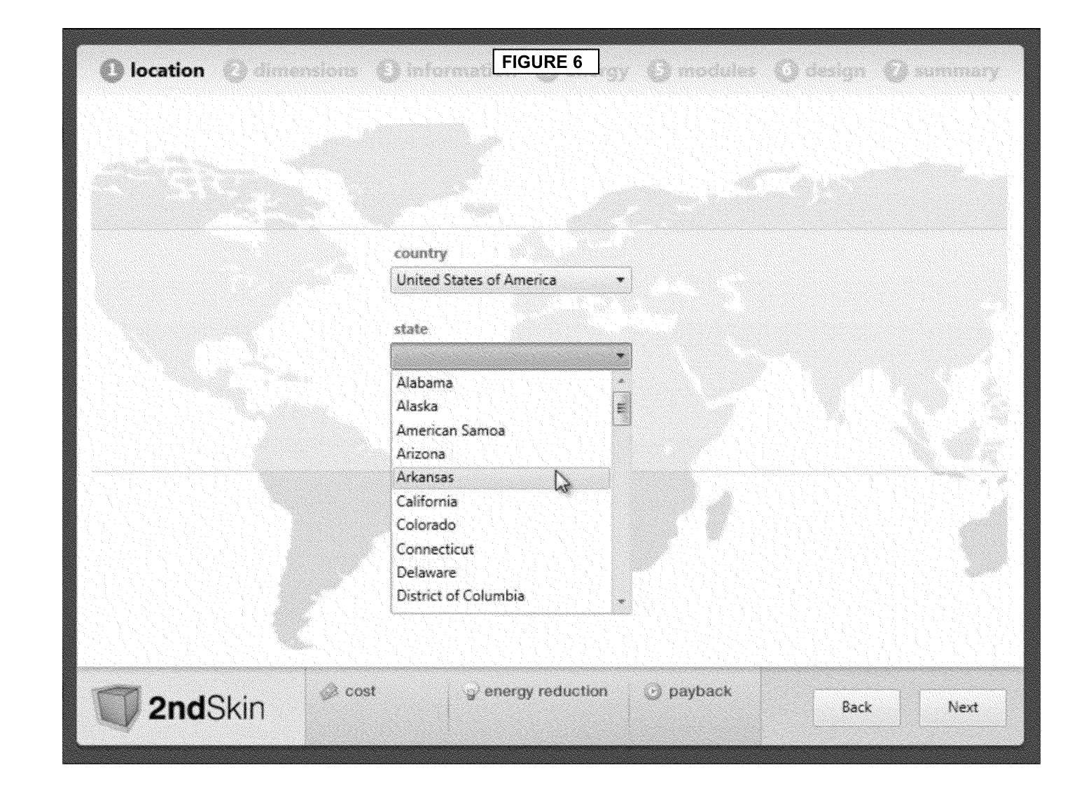

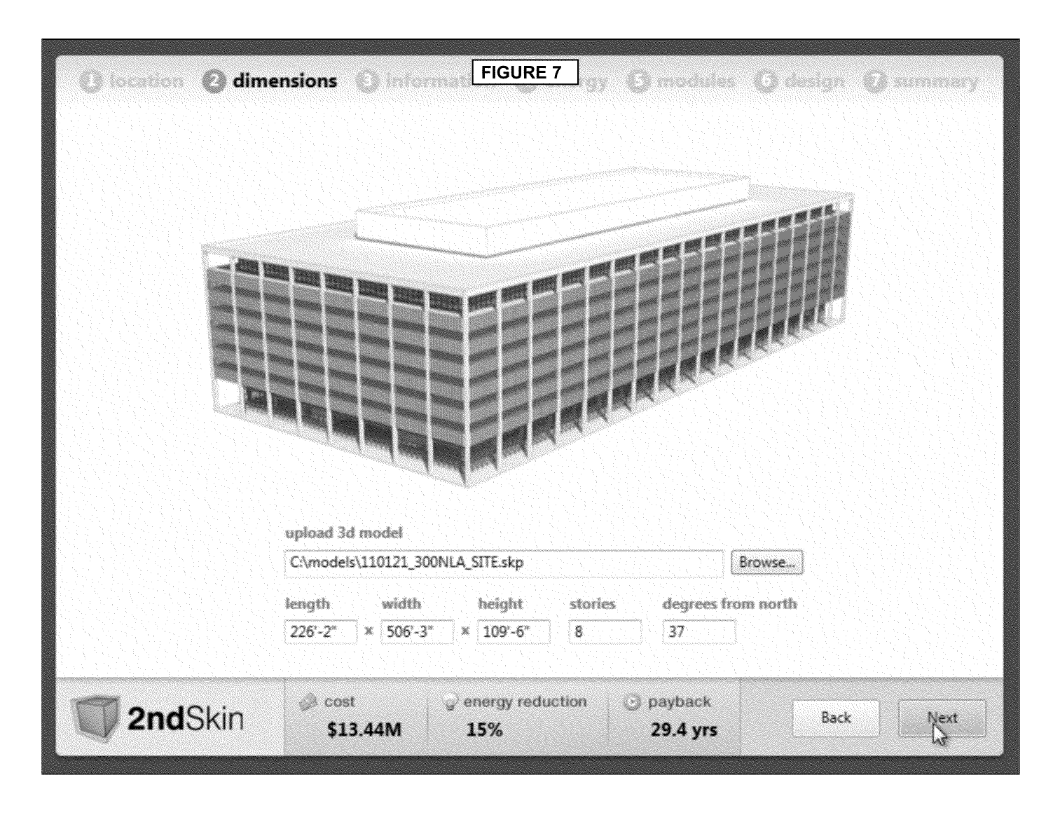

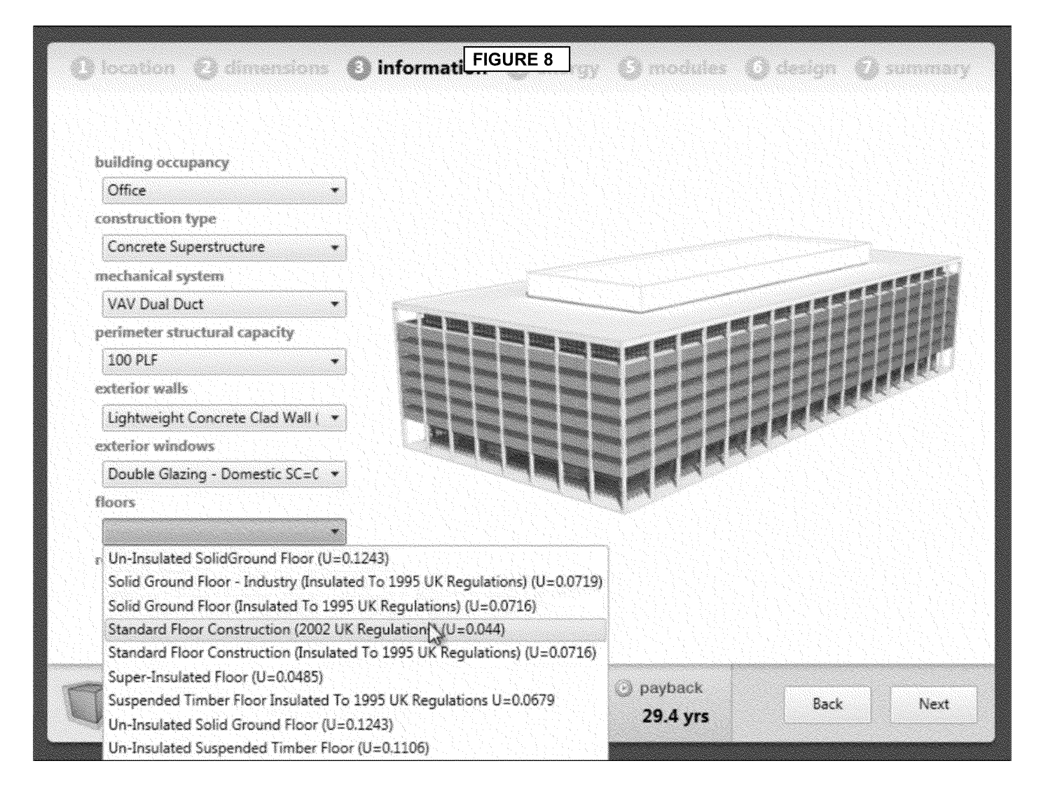

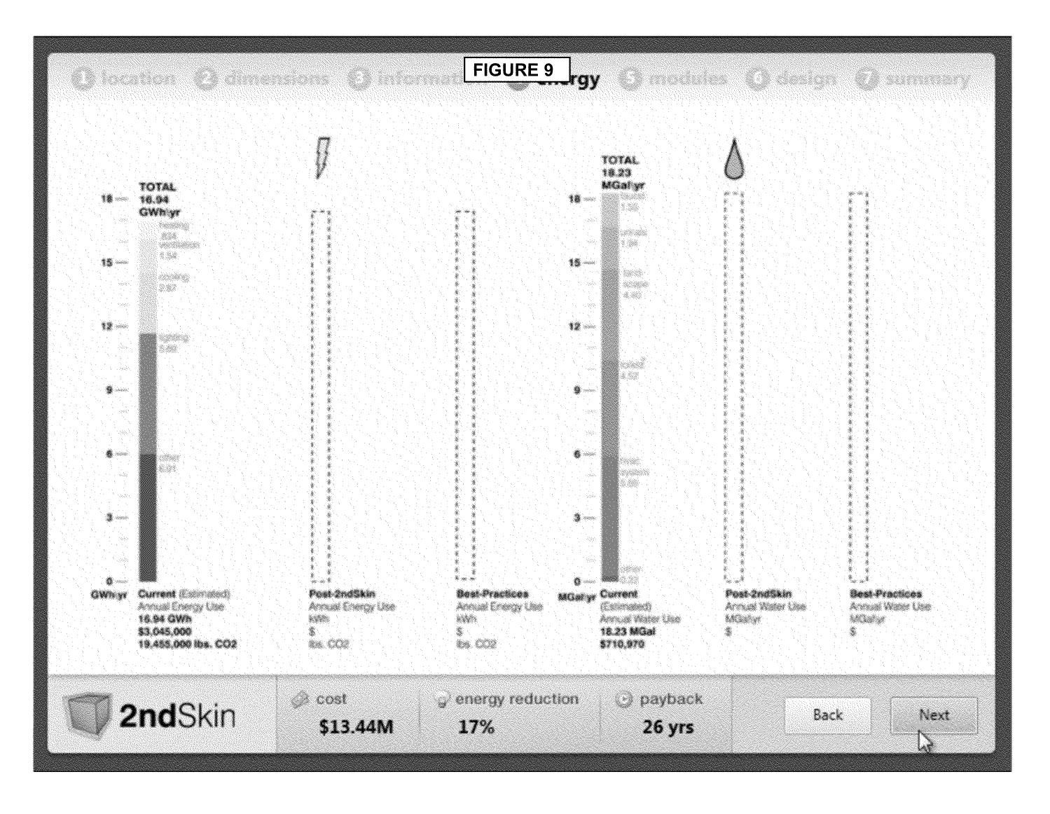

The software program taught by the present invention allows the user to enter site-specific data to model and estimate an existing building's current energy consumption and capacity to harvest energy from natural sources. FIGS. 6, 7 and 8 are exemplary embodiments of a software program receiving data entered by a user on the building's geographic location, orientation, dimensions, occupancy, construction type, mechanical system type, perimeter structural capacity, exterior wall construction, exterior window type, floor construction type, roof construction type. FIG. 9 is an exemplary embodiment of a software program's output based on this data, including estimates of the building's current energy consumption and capacity for reducing net energy consumption and costs.

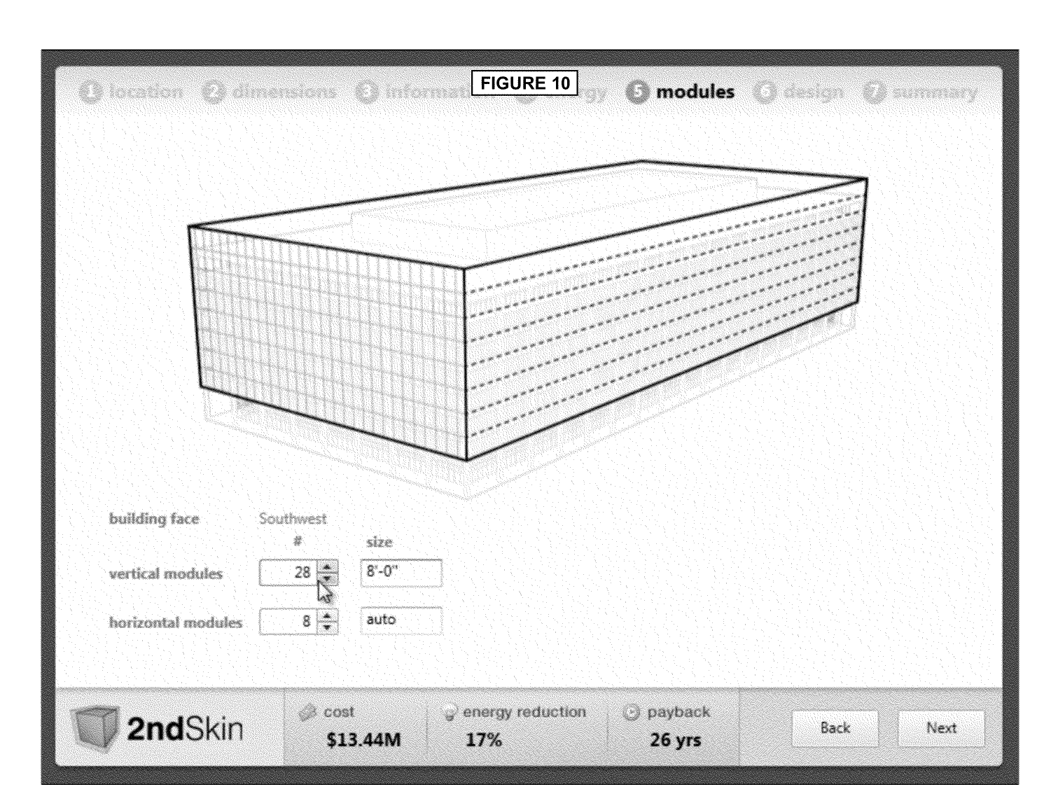

As shown by example in FIG. 10, the software program user then enters the desired number of vertical and horizontal cladding units for each façade of the existing building to determine the standard unit frame size.

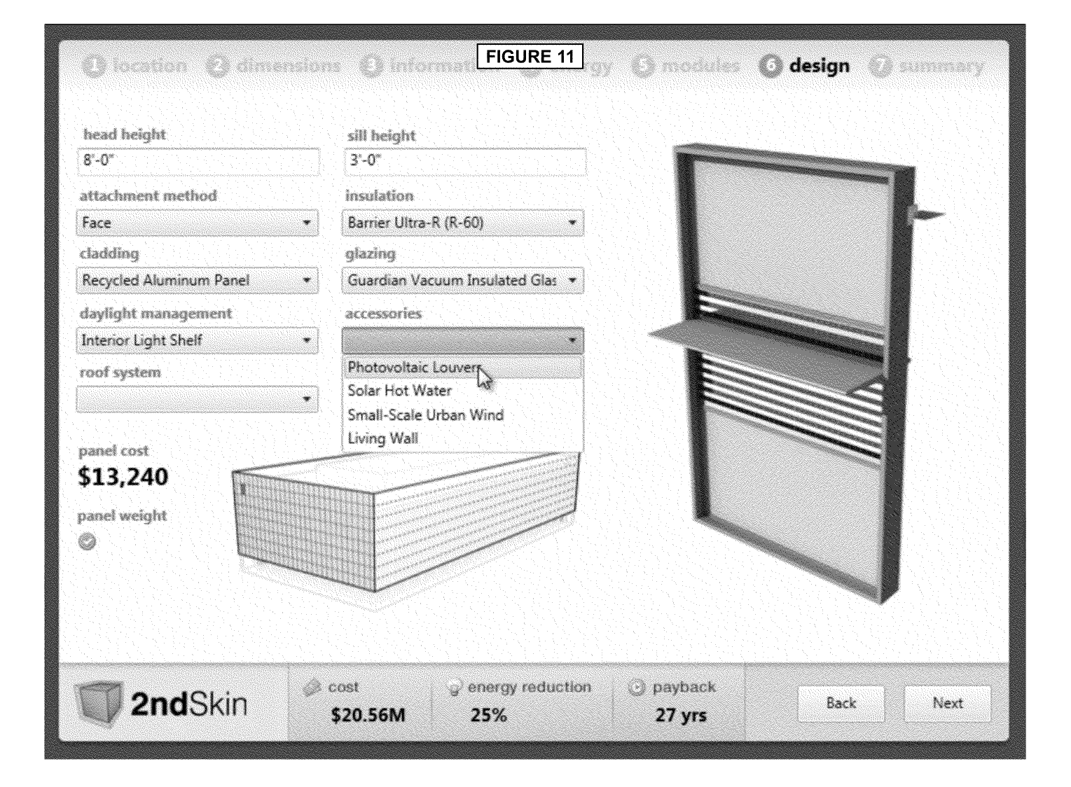

As shown by example in FIG. 11, the software program configures an individual cladding unit based on the user's selection of window head height and sill height, unit attachment method, insulation type, cladding type, glazing type, daylight management features, accessories, and-or roof systems. As these selections are made, the software program provides immediate feedback on reductions in energy consumption and costs based on the site-specific data that has been entered, and estimates the payback period based on predicted annual energy savings.

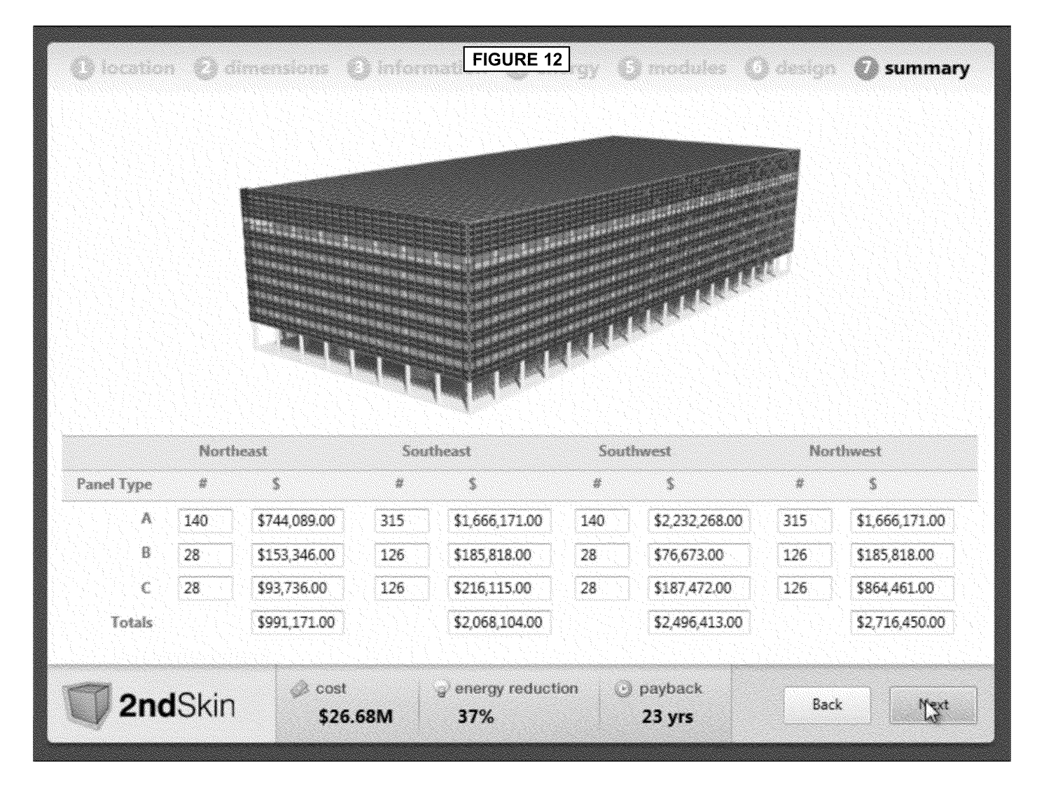

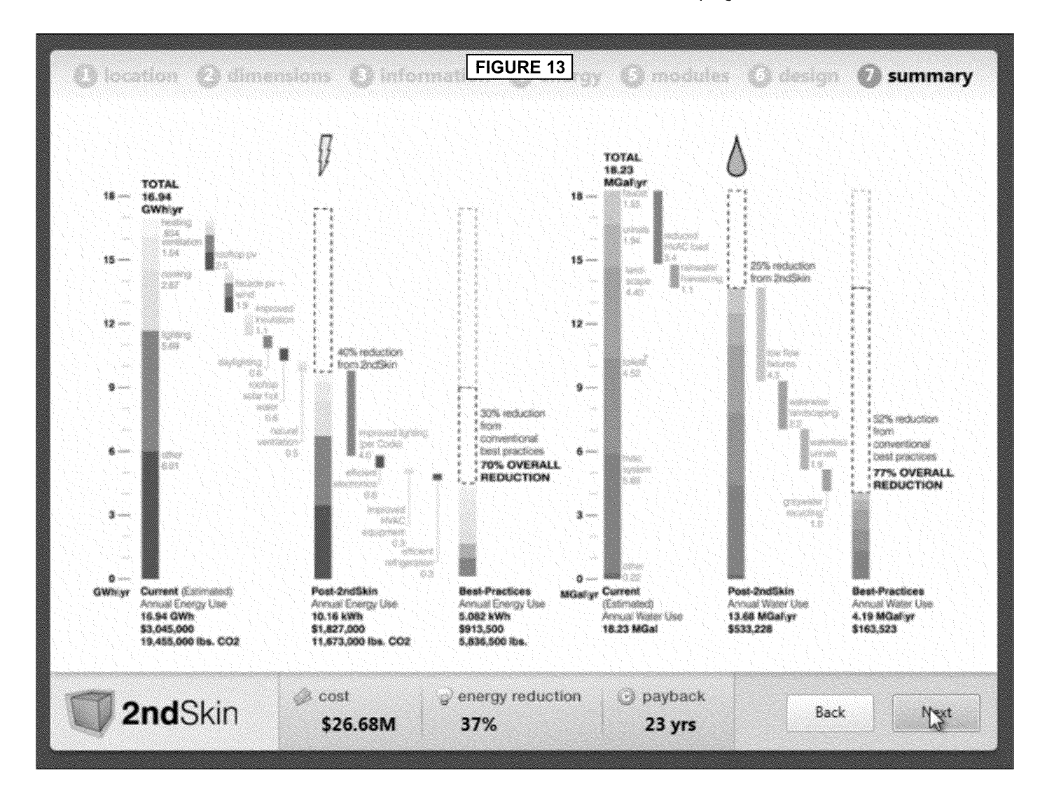

The configuration of the individual cladding unit may be applied to the remaining units on the building façade, or additional units may be configured using the same process. Once the cladding units for all façades of the building have been configured, the software program estimates the total cost, energy reduction, and payback period. FIGS. 12 and 13 are exemplary embodiments of a software program performing these estimates. The user may modify the configuration of the cladding system to achieve the desired values for these parameters.

According to the method taught by the present invention, once the cladding units for all façades of a building have been configured, the unit frames are fabricated off-site as a unitized cladding system that can be installed immediately and over a short period of time while the building remains occupied, minimizing the cost and disruption usually associated with façade replacement.

To assemble the unit frames, each module is attached to a module insert, which is then attached to vertical extrusions within the unit frame via a standardized extrusion for all module types. A variety of structural clips are used to accommodate different attachment methods required by various construction types and conditions. These structural clips are attached to the existing building structure in a pattern corresponding to the desired horizontal and vertical spacing. After the lips are attached to the existing structure, the pre-assembled cladding units are then bolted to the clips and attached to one another via interconnecting splines along the length of their extrusion.

The splines serve as physical and electronic interfaces between the modules, stabilizing them structurally, allowing power to be transmitted through the system to the building's electricity system, and transmitting data on the performance of the façade to building management software.

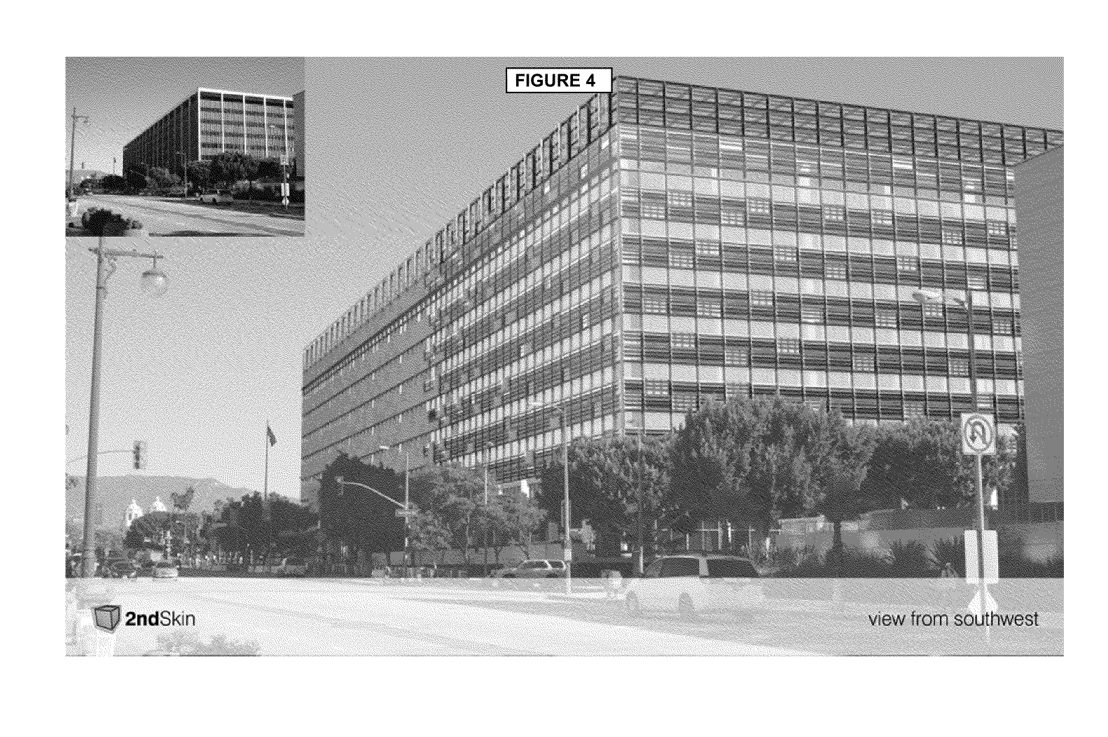

FIG. 4 is an example of an implementation of a unitized cladding system on the exterior of an existing building.

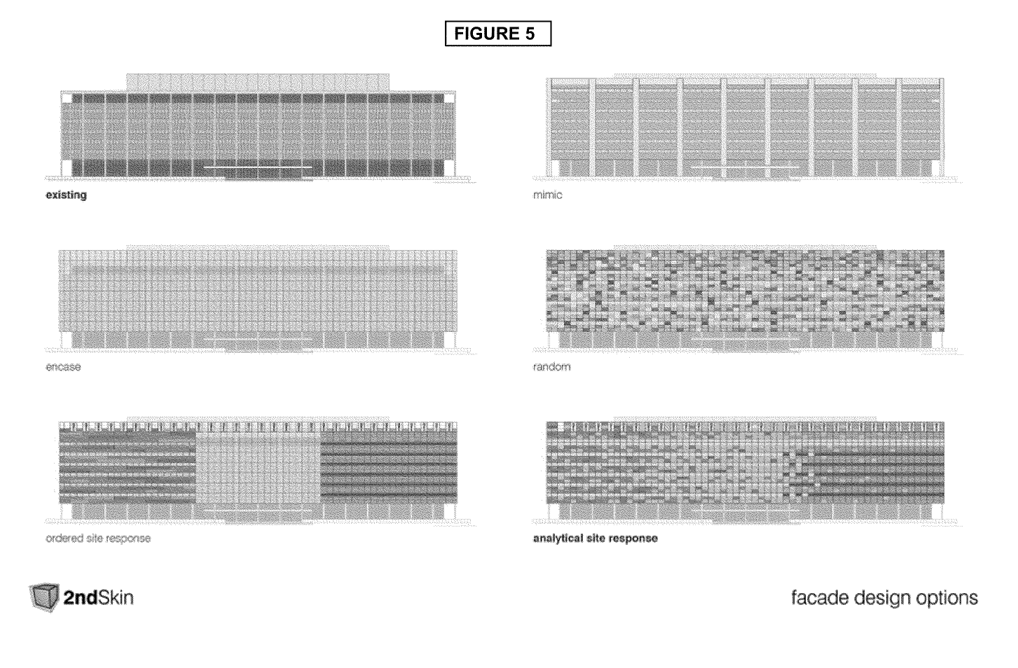

FIG. 5 is an example of variations in design of the unitized cladding system.

As new energy harvesting and conservation technologies become available, the cladding system may be upgraded by replacing or adding modules.

What is claimed is:

1. A unitized cladding system for installation on the exterior of an existing building that is comprised of a combination of modules to reduce energy consumption.

2. The unitized cladding system of claim 1 wherein a variety of structural clips are available to attach the cladding units to existing buildings of differing construction types and installation conditions.

3. The unitized cladding system of claim 1 wherein the connecting splines between horizontal and vertical mullions also use a standardized data and power transfer interface that is used to transmit power generated from the building façade to the building's electricity infrastructure, and data to a building management system.

4. The unitized cladding system of claim 1 wherein modules to reduce net energy consumption may include technologies such as: thin and high R-value lightweight insulation; decorative terra cotta, brick veneer, stone, fiber cement, aluminum, corrugated aluminum, wood plank, engineered wood, and ceramic tile finishes; high R-value glazing, photovoltaic integrated glazing, thermal storage glazing, operable windows, operable photovoltaic louvers, opaque and translucent louvers, vertical shading louvers, light shelves, brise soleil, and photovoltaic brise soleil, small scale wind, vegetated walls, and solar hot water units.

5. A method of reducing energy consumption of an existing building which comprises configuring a unitized cladding system incorporating energy conservation and production technologies.

6. A method of claim 5 which comprises modeling and measuring an existing building's energy consumption and capacity to harvest energy in order to configure a unitized cladding system incorporating energy conservation and production technologies.

7. A method of claim 5 which comprises calculating the reduction in an existing building's net energy consumption resulting from installation of a unitized cladding system.

8. A method of claim 5 which comprises calculating the cost of installing a unitized cladding system and the time period after which the savings in energy costs will have paid for the cost of installing the cladding system.

9. A software program product for reducing energy consumption of an existing building, wherein the software program product resides on a computer readable medium having computer readable program code, the program code comprising program code for configuring a unitized cladding system incorporating energy conservation and production technologies.

10. A software program product of claim 9 comprising program code for modeling and measuring an existing building's energy consumption and capacity to harvest energy to be used to configure a unitized cladding system incorporating energy conservation and production technologies.

11. A software program product of claim 9 comprising program code for calculating the reduction in an existing building's net energy consumption resulting from installation of a unitized cladding system.

12. A software program product of claim 9 comprising program code for calculating the cost of installing a unitized cladding system, and the time period after which the savings in energy costs will have paid for the cost of installing the cladding system.
